(19) United States
(12) Patent Application Publication
(10) Pub. No.: US 2017/0081862 A1
(43) Pub. Date: Mar. 23, 2017

(54) PRODUCTION OF TWO-LAYER COMPOSITE DECK TILE BY INJECTION MOLDING METHOD

(71) Applicant: Sema Plastik Kalip Ve Makine Sanayi Ve Ticaret Ltd. Sti., Istanbul (TR)

(72) Inventor: Semih GÜÇBILMEZ, Istanbul (TR)

(73) Assignee: Sema Plastik Kalip Ve Makine Sanayi Ve Ticaret Ltd.Sti., Istanbul (TR)

(21) Appl. No.: 15/310,551

(22) PCT Filed: Feb. 18, 2015
(86) PCT No.: PCT/TR2015/000081

§ 371 Date: Nov. 11, 2016

(30) Foreign Application Priority Data
May 14, 2014 (TR) 2014/05413

(51) Int. Cl. E04F 15/10; B29C 45/16; E01C 5/20; B32B 27/20; B32B 3/12; E04F 15/02; B29C 45/00; B29C 45/40

(52) U.S. Cl. CPC E04F 15/107; B29C 45/0013; B29C 45/16; B29C 45/40; B32B 27/20; B32B 3/12; E04F 15/02183; E04F 15/02188; E01C 5/20; B29K 2511/14

(57) ABSTRACT

The present invention is related to the production method of the two-layer composite deck tile (1) which comprises the process steps of melting, first of all, the wood-plastic filling material which is used as the top layer (10) and filling the same into the prepared injection mold cavity; then melting the thermoplastic bottom layer (11) which allows the composite deck tile (1) to be high-positioned on the ground where it will be applied and filling the same into the injection mold cavity; allowing the two layers (10, 11) to cool down which are filled into the mold cavity; and removing thereof from the mold after cooling down, so as to be used in the outdoor areas or for floor coverings.

### TECHNICAL FIELD

The present invention relates to the wood-plastic composite materials used in the outdoor areas such as garden paths, footbridges, children's playground, balconies, walking paths, winter gardens, poolside, marinas, docks, beaches, pergolas, porches, camellias and terraces, boats and yachts, sun terraces, and areas having a risk of slippery ground and in the indoor areas such as saunas, hotels, restaurants, cafes, and houses.

### STATE OF THE ART

The deck tile refers to the floor covering in wet grounds which is produced utilizing wood-plastic mixture composite materials used in flooring today. Said wood-plastic composites cannot be used in the plastic injection machines because of the yield strength and physical endurance thereof and can only be used in specifically-produced plastic extruder machines. The wood-plastic composite used in the extruder can only be used for the production of the products having a flat form such as a profile and cannot be used for the production of the products having indent-protrusion details such as trays, plates, toy pieces, and clothes hangers.

The composite materials can only be produced by the extrusion method in the state of the art. A deck tile is produced by sizing the flat profiles obtained with said method and combining the same by means of various connection members. However, said method brings along some disadvantages.

One of these disadvantages is the raw material losses which occur while sizing the flat profiles and combining the same by means of various connection members.

Another one of these disadvantages is the time loss and labor costs arisen while sizing the profiles to be combined and mounting the same.

One of these disadvantages is that the product produced by the extrusion method has a low production capacity and increased energy expenses.

A further disadvantage is that the material quality depends on the quality of the production methods due to the restricted nature of the production method. Therefore, a standardized quality cannot be achieved.

A similar disadvantage suggests that the product produced by the extrusion method does not have an aesthetic look.

Some applications are encountered during the literature search.

One of them is the utility model application numbered TR200707593 and titled ‘Composite wood-reinforced plastic panel’. The invention is related to the composite wood-reinforced plastic panel used in the construction sector. Said panel is used for obtaining molds for the concrete structures which constitutes the carrier element of the building in the reinforced concrete building construction. It can be used for many times owing to the composite structure thereof having various layers and provides convenience during the application.

In conclusion, due to the drawbacks discussed above and the inadequacy of the existing solutions with respect to the subject, a development is deemed necessary in the technical field regarding the production of the deck tiles.

### OBJECTS OF THE INVENTION

The present invention relates to the production of two-layer composite deck tile by injection molding method meeting the abovementioned requirements, eliminating the disadvantages of the prior art, and introducing some additional advantages.

The object of the invention is to allow the production of two-layer wood-plastic composite materials with the injection method.

An object of the invention is to provide the deck tiles produced by this method with certain characteristics which are recycling, cost-efficiency, long-term endurance, enhanced capacity, aesthetic look, moisture resistance, fire resistance, oxidation resistance, water resistance, and high dimensional stability.

Another object of the invention is to obtain a final product in a single process without any need for re-sizing the flat profiles and combining the same as in the prior art.

A similar object of the invention is to offer resistance to the fungi and insects, suitability for all kinds of atmospheric conditions, impact resistance, resistance to slide, easy mounting, saving on labor, decorativeness, and minimum maintenance.

Another object of the invention is to contribute to the recycling by utilizing the waste materials for the production of the deck tile materials.

Another object of the invention is to be healthy and antibacterial, to be painted and polished any time, and not to be mossed.

In order to achieve the preceding objects, the present invention is a production method for two-layer composite deck tiles made of wood-plastic mixture composite material so as to be used in the outdoor and indoor areas or for floor coverings, characterized in comprising the following process steps;
melting, first of all, the wood-plastic filling material which is used as the top layer and filling the same into the prepared injection mold cavity,
then melting the thermoplastic bottom layer which allows the composite deck tile to be high-positioned on the ground where it will be applied and filling the same into the injection mold cavity,
allowing the two layers to cool down which are filled into the mold cavity,
removing the same from the mold after cooling down.

The structural and characteristic features and all the advantages of the invention will be clearly understood thanks to the figures given below and the detailed description composed with reference to these figures. Therefore, the evaluation needs to be done by taking into consideration these figures and the detailed description.

### FIGURES FACILITATING THE UNDERSTANDING OF THE INVENTION

The present invention needs to be assessed together with the figures described below in order to make the best understanding of the embodiment and the advantages thereof together with the additional elements.

FIG. 1A illustrates the bottom perspective view of the two-layer composite material produced by the injection method according to the invention.

FIG. 1B illustrates the bottom perspective view of the two-layer composite material produced by the injection method according to the invention and comprising an alternative embodiment.

FIG. 2 illustrates the two-dimensional side view of the two-layer composite material produced by the injection method according to the invention.

The drawings do not have to be scaled necessarily and the details not required for understanding the present invention may have been ignored. Besides, the elements which are at least substantially identical or have at least substantially identical function are shown with the same numerals.

### DESCRIPTION OF THE PART REFERENCES

1. Two-layer composite deck the

10. Wood-plastic top layer

11. Thermoplastic bottom layer

The drawings do not have to be scaled necessarily and the details not required for understanding the present invention may have been ignored. Besides, the elements which are at least substantially identical or have at least substantially identical function are shown with the same numerals.

### DETAILED DESCRIPTION OF THE INVENTION

In this detailed description, the preferred embodiments of the two-layer composite deck tile (1) according to the invention are described only for a better understanding of the subject.

The composite deck tile (1) according to the invention is a composite structure containing wood and plastic mixture in order to be used in the outdoor and indoor areas or for the floor coverings and comprises two layers (10, 11). These layers are the top layer (10) which is used as a filling material and the thermoplastic bottom layer (11) via which the product (1) is fitted on the ground where it will be applied, which protects the product, provides high position for the same, and ensures that said product is not damaged on the ground on which it will be fitted.

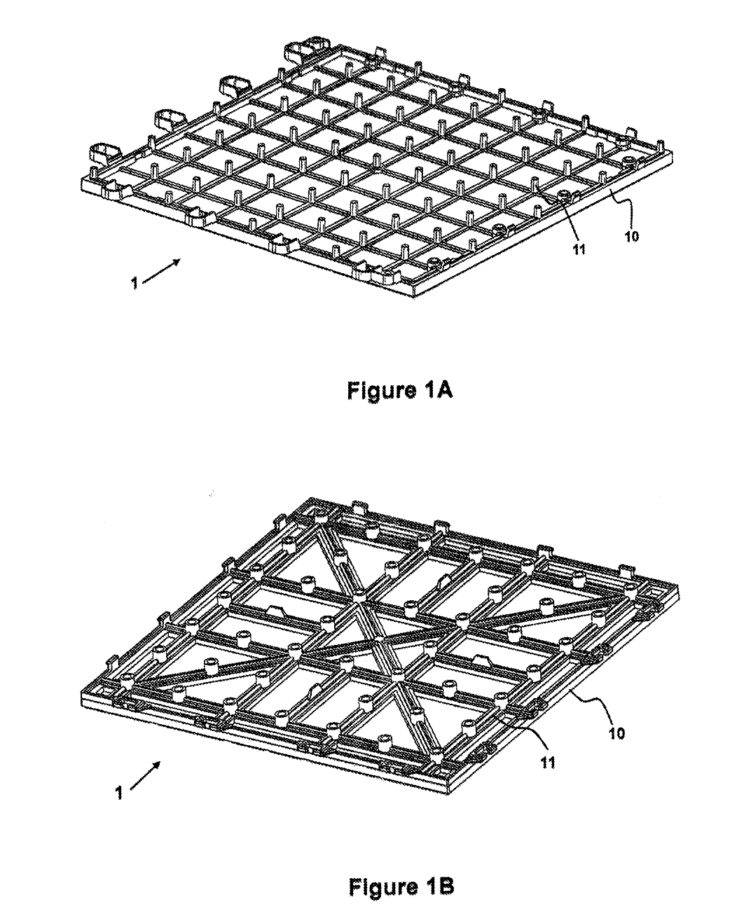

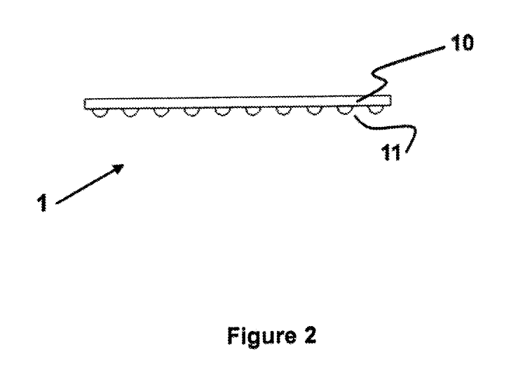

FIGS. 1A and 1B illustrates the bottom perspective view of the two-layer composite deck tile (1) produced by the injection method according to the invention.

The wood-plastic filling material constitutes the top layer (10) of the two-layer composite deck tile (1) according to the invention. Said filling material is obtained with the mixture of the wood and plastic substances. One of the most important raw materials to obtain this piece is the tree powder. The tree powder is used as the filling material for the product (1) according to the invention.

It is essential to know the structure of the tree and the role thereof in the composite which it will constitute together with the polymer so as to obtain a good product. As a result of the searches carried to this end, it is decided to prefer the tree powder as the material to be used as the composite mixture.

The preferred tree powders are combined with the polymer via binders and it is ensured that the tree powder and the plastic are adhered. Furthermore, in the preferred embodiment of the invention, certain chemical additives may be added in order for the product to contain the characteristics which are desired to be brought to the composite material (1). The product is provided with characteristics which enhance the physical properties of the product such as strength resistance, UV resistance, impact resistance, high resistance to atmospheric conditions and the like. The formulation for the content of the additives used is quite important. It is necessary to be cautious about which chemical substance will be incorporated at what rate. The desired product is obtained with the right formulation by carrying out laboratory studies to this end.

The bottom layer (11) of the product (1) according to the invention is on the other hand produced by the injection method using thermoplastic raw materials (a polymer such as PE, PP, ABS, EPDM, and PA). Said bottom layer (11) cuts off the connection between the composite deck tile (1) and the ground and provides an easy-mounting environment. Besides, it prevents the composite deck tile (1) from being damaged on the ground on which the product will be fitted and provides high position for said product.

In the preferred applications of the invention, said thermoplastic bottom layer (11) can have a geometrical form such as cubical, hemispherical, and prism form which is formed at regular or irregular intervals as seen in FIGS. 1A and 1B.

### Production Method

The two-layer composite deck tile (1) is formed by melting said top (10) and bottom (11) layers and filling the same into the molds prepared in a desired form and size depending on the place of use and then by removing thereof from the mold after cooling down. This process is named as injection.

The production method of the two-layer composite deck tile (1) according to the invention is as follows;
melting, first of all, the top layer (10) which is a wood-plastic filling material and filling the same into the prepared injection mold cavity,
then melting the thermoplastic bottom layer (11) and filling the same into the mold cavity,
waiting for the two layers (10, 11) to cool down which are filled into the mold cavity,
removing thereof from the mold after cooling down and thereby being ready for use.

1. A production method for two-layer composite deck tiles (1) made of wood-plastic mixture composite material so as to be used in the outdoor and indoor areas or for floor coverings, characterized in comprising the following process steps;
melting, first of all, the wood-plastic filling material which is used as the top layer (10) and filling the same into the prepared injection mold cavity,
then melting the thermoplastic bottom layer (11) which allows the composite deck tile (1) to be high-positioned on the ground where it will be applied and filling the same into the injection mold cavity,
allowing the two layers (10, 11) to cool down which are filled into the mold cavity,
removing thereof from the mold after cooling down.

2. A two-layer composite deck tile (1) which is obtained with the method described in claim 1.

3. The composite deck tile (1) according to claim 2, characterized in that said wood-plastic top layer filling material (10) contains tree powder, plastic, binders, and additive chemicals.

4. The composite deck tile (1) according to claim 2, characterized in that said thermoplastic bottom layer (11) is made of a polymer material such as PE, PP, ABS, EPDM, and PA.

5. The composite deck tile (1) according to claim 2, characterized in that said thermoplastic bottom layer (11) has geometrical forms such as cubical, hemispherical, and prism forms which are formed at regular and/or irregular intervals.
